(19) United States
(12) Patent Application Publication
(10) Pub. No.: US 2008/0069311 A1
(43) Pub. Date: Mar. 20, 2008

(54) Recording calls in a telecommunication network

(75) Inventor: Jean-Pierre Mercuriali, Orsay (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: AASTRA MATRA TELECOM, Guyancourt (FR)

(21) Appl. No.: 11/775,560

(22) Filed: Jul. 10, 2007

(30) Foreign Application Priority Data
Jul. 13, 2006 (FR) FR 06 06430

(51) Int. Cl. H04M 1/64

(52) U.S. Cl. 379/85

(57) ABSTRACT

To record a call between a calling terminal and a called terminal in a telecommunication network, on a call server (12) to which is linked a recording device (16), a setup request (301, 602) is received which indicates a call profile of the calling terminal and an identifier of the called terminal. An initiation message (303, 603) is transmitted to the device which indicates the call profile of the calling terminal. A setup request (306, 607) is then transmitted to the called terminal, indicating a call profile of the device. A setup response (309, 608) is received from the called terminal indicating a call profile of the called terminal. An update message (311, 611) is then transmitted to the device indicating the call profile of the called terminal and a response (314, 609) is transmitted to the calling terminal indicating a call profile of the device.

The present invention relates to the recording of calls in a telecommunication network, more specifically in a telecommunication network based on a packet mode data transmission protocol such as IP (Internet Protocol).

In a telephony over IP network, the signaling relating to a call is managed by an IP call server, called IP PBX (standing for Private Branch Exchange), whereas the transmission of the useful data (voice data) follows a different path that does not use this type of IP call server.

Such management is different from that implemented in a conventional (non-IP) telephony network. In practice, in the latter case, for a terminal managed by a conventional PBX exchange, the transmission of the signaling and that of the voice of one and the same call pass through this PBX exchange.

This difference means that the known solutions that are implemented for recording calls in a conventional telephony network cannot easily be transposed into an IP-type telecommunication network.

In practice, in a conventional telephony network, it is possible, for example, to provide for the recording of a call involving a given terminal by linking a recording device to this terminal via the PCM (Pulse Code Modulation) link used for this call. Then, based on the telephone numbers of the calling terminal and of the called terminal which are included in the signaling of the various calls that pass via this PCM link, it is possible to select the calls that correspond to the terminal involved in the recording, in other words either the calling terminal or the called terminal.

The explanation of the technical solutions given below is based on the consideration of the inventors, and in no way constitutes acceptance of a known prior art.

In order to transpose the method applied in conventional telephony to IP telecommunication networks, it would be possible to allow for calls to be recorded on the IP call server.

Such a method would be complex to implement since, in this type of network, it is difficult, for the reasons stated above, to correlate the signaling and the transmitted data, and because of this, it is difficult to identify the data relating to the terminal involved in the recording. Furthermore, in a large telecommunication network, such a method would entail providing for the possibility of implementing recording functions on a large number of IP call servers.

It would also be possible to provide for installing an automatic initiation of a call to a recording device from the terminal involved in the recording. Such automatic initiation is possible on a terminal having first and second “legs”. This automatic call initiation would consist, for example, in making a call over the second leg from the terminal concerned, when the first leg from this terminal is used either to receive a call or to initiate a call. Such a solution would, however, present the drawback of using the second leg from the terminals and, because of this, preventing the use of the functionalities that rely on this second leg, such as call transfer, broker's-call or even conferencing call functionalities.

Furthermore, by proceeding in this way, the recording of a call would be initiated only after the first leg from the terminal concerned had been invoked, by receiving a call or by initiating a call. Consequently, the recording of the call could be done effectively only after the start of the call. In such conditions, it is probable that certain information would not be recorded.

Furthermore, since the automatic initiation of the call to the recording device would be performed after the call had been set up, the result would be, in the case of a voice call, that the user of the terminal concerned could be hindered by a noise generated by this call to the recording device.

The present invention aims to allow calls to be recorded in a telecommunication network based on a packet mode data transmission protocol, without the drawbacks of the abovementioned solutions.

A first aspect of the present invention proposes a call recording method for a given terminal, during a call between a calling terminal and a called terminal in a telecommunication network, said given terminal, corresponding to the calling terminal or to the called terminal, being managed by a call server linked to at least one recording device.

The method comprises the following steps, implemented on the call server:
/a/ receiving a call setup request indicating a first calling call profile corresponding to the calling terminal and a called party identifier corresponding to the called terminal;
/b/ transmitting to the recording device a recording initiation message indicating said calling call profile corresponding to the calling terminal;
/c/ transmitting, to the called terminal, a call setup request indicating a second calling call profile corresponding to said recording device;
/d/ receiving from the called terminal a call setup response indicating a first called call profile corresponding to the called terminal; and
/e/ transmitting, on the one hand, to the recording device, an update message indicating the first called call profile and, on the other hand, to the calling terminal an answer message indicating a second called call profile corresponding to said recording device.

The established call comprises, on the one hand, a first call part between the calling terminal and the recording device, and, on the other hand, a second call part between the recording device and the called terminal.

Furthermore, the recording device records data concerning the call received from the calling terminal and/or data concerning the call received from the called terminal.

The terms “calling call profile” and “called call profile” should be understood to mean the information that enables, in the telecommunication network concerned, the called party to transmit the call data to the calling party, and the information that enables the calling party to transmit the call data to the called party, respectively.

With these arrangements, it is possible to record, on the recording device, the calls of a given terminal, that is, it is possible to record the call data that this given terminal receives or the call data that this given terminal transmits, from the start of the call and transparently for the user of this terminal.

In practice, such a recording function is initiated ahead of the complete setup of the call concerned, since the recording device is invoked before even the call server has transmitted the call setup message to the called party.

This characteristic contributes to the transparency of the recording of the call for the user of the terminal concerned. In practice, in particular in the context of a voice call, recording according to embodiments of the present invention is inaudible, since it is initiated before the call is set up.

Also, this characteristic makes it possible to record a call in full, and, consequently, even include the start of the call.

Furthermore, no “leg” from the terminal involved in the recording is used for such a recording. This terminal can therefore continue to use the functionalities offered to it based on its second “leg” while its call is being recorded.

The recording device receives both the first calling call profile corresponding to the calling terminal and the first called call profile corresponding to the called terminal, then the calling terminal receives the called call profile corresponding to the recording device and the called terminal receives the calling call profile corresponding to the recording device. A call set up in this way therefore takes the form of a first part corresponding to the link between the calling terminal and the recording device and a second part corresponding to a link between the recording device and the called terminal. The recording device is therefore located between the calling terminal and the called terminal with respect to the current call. It is therefore responsible for receiving and transmitting the data exchanged between these two terminals on the basis of the duly established call. It can then record this data, without using another “leg” from the terminal involved in the recording.

In such a context, a terminal which has two “legs” is therefore still able to carry out transfers, conferences or other functionalities that require a second “leg”.

Moreover, whether the terminal involved in the recording corresponds to the calling terminal or to the called terminal, when this terminal is involved in a call, it is possible to initiate a recording of this call. In practice, initiation is performed on receipt of a call setup request message in which the terminal concerned is invoked as calling or called party. Based on information contained in the call setup request message, the call server can therefore determine whether the call currently being set up requires recording or not on the basis of corresponding information, provided for this purpose.

Moreover, such a method can easily be implemented in any type of telecommunication network and for any type of call, such as, for example, voice calls or even data calls. With such provisions, it is possible to record any type of call that can be managed in the telecommunication network concerned, for all of the call.

In one embodiment, when call recording is required for a plurality of terminals of the telecommunication network that are managed by one and the same call server, the call server manages a list of identifiers relating to the terminals of this plurality of terminals. In this context, the steps /b/ to /e/ are implemented only if the calling call profile and/or the called party identifier correspond(s) to an identifier in this list.

When the telecommunication network is based on an IP-type protocol, a call profile can comprise at least an IP address and an IP port for receiving data. Thus, the calling, respectively called, call profile indicates the address and IP port on which the calling terminal, respectively the called terminal, receives the call data.

A calling, respectively called, call profile corresponding to the recording device can indicate the IP address and the IP port on which the recording device receives the call data from the called party, respectively from the calling party.

It is also possible to provide for embodiments in which the call server is linked to a plurality of recording devices. In this context, the call server can manage a list of recording devices, and select a recording device from the recording devices in the list according, on the one hand, to information indicated in the call profile of the calling party and, on the other hand, to information relating to the recording devices in the list.

Thus, the call server can select a recording device on the basis of the type of call currently being set up. In particular, it is possible to provide for a recording device suitable for recording voice-type calls and a recording device suitable for data-type calls.

It is also possible to provide for the selection of a recording device to be based on the respective loads of the various recording devices in the list managed.

No limitation is stated as to the criteria governing such a selection and the present invention covers any type of selection of a recording device from a list.

A second aspect of the invention proposes a call server suitable for implementing a recording method according to the first aspect.

A third aspect of the present invention proposes a recording device suitable for implementing a recording method according to the first aspect.

Finally, a fourth aspect of the present invention proposes a recording system comprising a call server according to the second aspect and a recording device according to the third aspect.

Other characteristics and advantages of the invention will become more apparent from reading the description that follows. This is purely illustrative and should be read in light of the appended drawings in which:

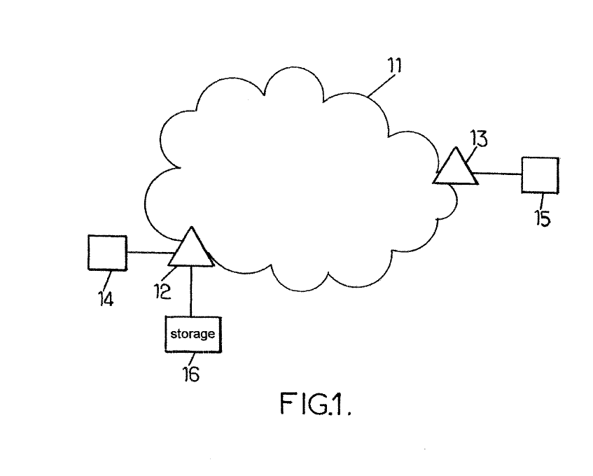

FIG. 1 is a diagrammatic representation of a telecommunication network according to one embodiment of the present invention;

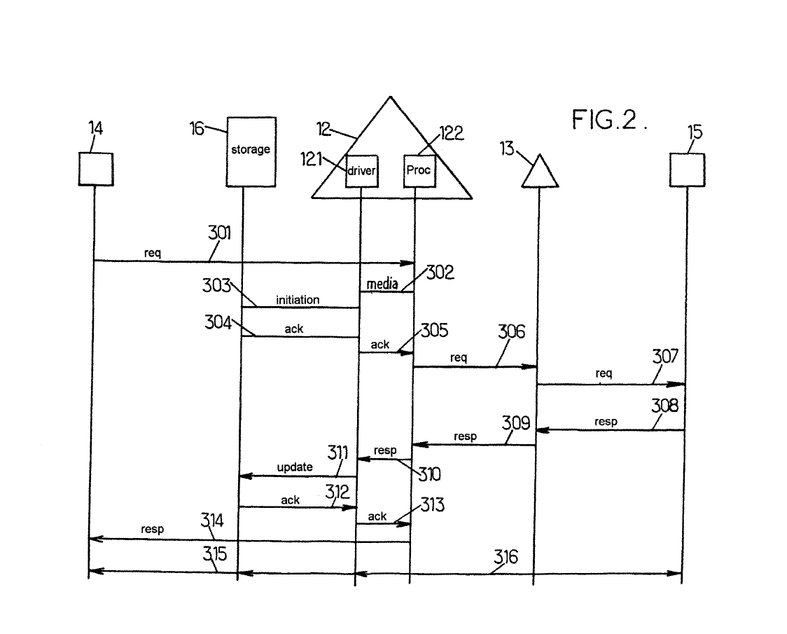

FIG. 2 illustrates an exchange of messages between a calling terminal, a called terminal and various network elements according to one embodiment of the present invention, when the terminal involved in the recording is the calling terminal;

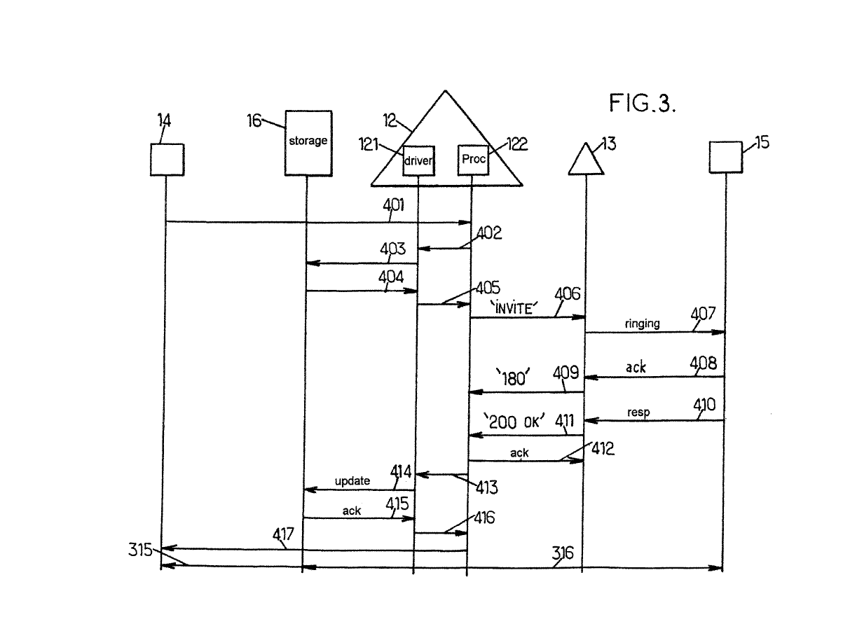

FIG. 3 illustrates an exchange of messages as illustrated in FIG. 2 in the context of the SIP protocol;

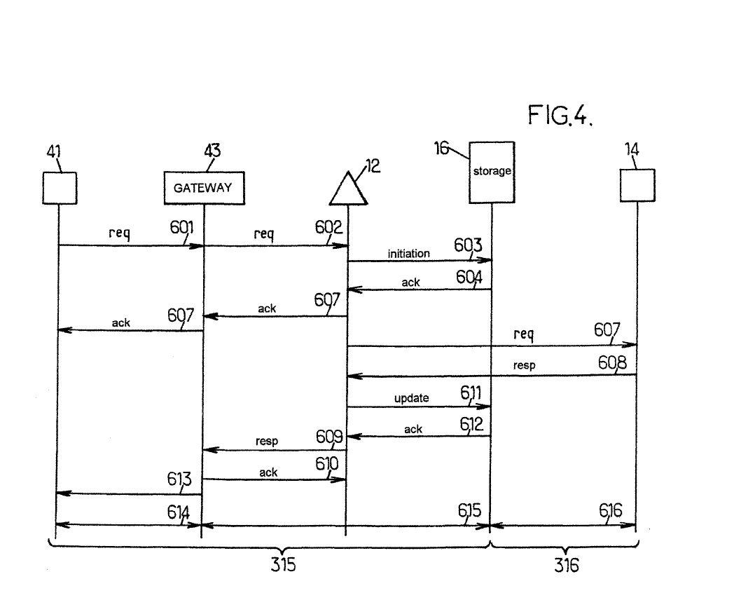

FIG. 4 illustrates another exchange of messages between a calling terminal, a called terminal and various network elements according to one embodiment of the present invention, when the terminal involved in the recording is the called terminal;

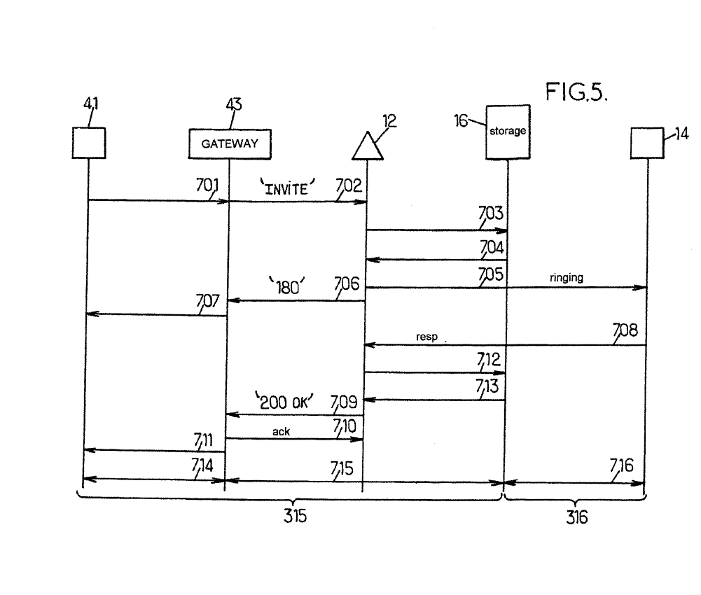

FIG. 5 illustrates an exchange of messages like that illustrated in FIG. 4 in the SIP protocol context; and

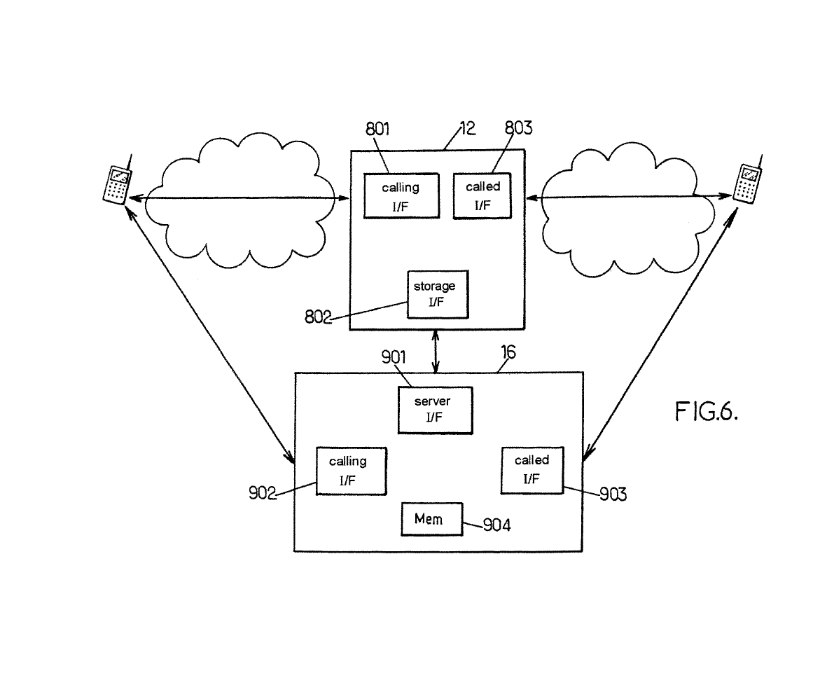

FIG. 6 illustrates a -call server and a recording device according to one embodiment of the present invention.

FIG. 1 illustrates a telecommunication network 11 comprising a first call server 12 responsible for managing calls from a terminal 14 and a second call server 13 responsible for managing calls from a terminal 15. The call server 12 is also connected to a recording device 16.

In one embodiment of the present invention, the telecommunication network 11 can support an IP-type packet transmission protocol.

The calling and called terminals can, for example, belong to this same telecommunication over IP network.

One embodiment of the present invention can easily be implemented in various types of telecommunication networks. In practice, no limitation is given as to the type of telecommunication network in which the calling terminal and/or the called terminal are located. Thus, the telecommunication network 11 can comprise various types of networks interconnected by ad hoc gateways.

In the following sections, by way of example, the part of the call that is not involved in the recording is located in a telecommunication network of the same type as that in which the part of the call that is involved in the recording is located. In a variant, this part not involved in the recording is located in a telecommunication network of a different type from the part involved in the recording, one part of the call then being located in an IP-type network and the other part of the call being located in a TDM (Time Division Multiplexing) type network.

FIG. 2 illustrates an exchange of messages between a calling terminal, a called terminal and various network elements according to one embodiment, when the terminal involved in the recording is the calling terminal and when the network is an IP-type network. In the network concerned here, a call server 12 manages a terminal 14 and a call server 13 manages a terminal 15. Thus, it is possible to differentiate a first type of protocol enabling exchanges of information between a call server and a terminal, and a second type of protocol enabling exchanges of information between two call servers. The first type of protocol can be, for example, a proprietary protocol and the second type of protocol can be, for example, an SIP (Session Internet Protocol) type protocol, like that defined by the IETF (Internet Engineering Task Force).

During this exchange of messages, a terminal 14 sends a call setup request to the call server which is responsible for managing the calls from this terminal. To this end, it transmits a call setup request message 301 to the call server 12. This message indicates a calling call profile corresponding to the terminal 14. Such a call profile indicates the information required, according to the call setup protocol used, to set up a call between the calling and the called parties. Thus, this information can indicate in particular the address for receiving the data stream relating to the call concerned, at the calling end.

On receipt of this message 301, the call server 12 is then able to transmit a recording initiation message 303 to the recording device 16. This initiation message indicates the call profile of the terminal 14. It can also include an indication relating to the type of medium that will be used for the data stream in the call currently being set up.

On receiving this initiation message, the recording device 16 can prepare for the recording, in particular by updating certain information in a database. When it is able to take over this recording, it responds to the call server by transmitting an acknowledgement message 304.

In one embodiment, the call server 12 comprises a call manager 122, suitable for managing calls, and a media driver entity 121. In such a context, the call manager 122, on receiving a call setup request 301, interrogates the driver 121, by transmitting a media choice message 302, in order to determine the medium to be used during this requested call. In practice, it is possible to provide for such a call server to be able to manage a plurality of call types, such as, for example, a voice call or a data call, each type possibly corresponding to a different medium.

In this context, the driver 121 of the call server 12 is responsible for managing the interface with the recording device 16. Thus, the driver transmits the initiation message 303 which indicates the type of medium that will be used for the call currently being set up, and receives the acknowledgement message 304 from the recording device 16. Then, the driver 121 transmits this acknowledgement message to the call manager 122 in the form of an acknowledgement message 305.

At this stage, the recording device 16 is ready to record a call initiated by the terminal 14, that is, this device is ready to record data exchanged with the terminal 14 during the call that is currently being set up.

Then, the call server 12 proceeds to transmit a call request message to the called terminal, that is, the terminal 15. To this end, the call server 12 transmits a call request message 306 to a call server 13 which is responsible for managing the calls involving the terminal 15, which corresponds to the called party. This call setup request message indicates the calling call profile corresponding to the recording device 16. Such a message can be transmitted according to any protocol corresponding to exchanges between call servers.

The call server 13, on receiving this setup request message 306, transmits a call setup request message 307 to the called terminal 15 according to the protocol used between the call server 13 and the terminals that it is responsible for managing.

The terminal 15 responds to this request by transmitting an answer message 308 to the call server 13. The latter then transmits an answer message 309 to the call server 12.

It should be noted that this exchange of messages between the call server 12, the call server 13 and the called terminal 15 can advantageously remain substantially compliant with that implemented when a recording of the call is not required, except for the fact that the calling call profile is modified in the setup request message 306. In practice, this call profile here corresponds to the recording device.

On receiving the answer message 309, the call server 12 updates the information recorded by the recording device 16 on the basis of information contained in the answer message 309 received from the called party 15, by transmitting an update message 311. The update message indicates the called call profile corresponding to the terminal 15. The information contained in this call profile corresponds in particular to the address in the network at which the terminal 15 will receive the data sent by the terminal 14, when the call is set up. The recording device 16 responds with an acknowledgement message 312 for this update.

It is possible to provide, in certain cases, for this update step of the recording device 16 to be able not to be required. In practice, when the recording device already knows the information that is contained in the answer message 309, this update message is pointless. This can be the case when the setup request message transmitted by the calling terminal already indicates a called call profile corresponding to the terminal 15.

Furthermore, the call server 12 transmits to the calling terminal 14, a call answer message 314. This call answer message 314 indicates a called call profile corresponding to the recording device 16. By proceeding in this way, an indication is given to the calling terminal that, to communicate with the called terminal, it must use the called call profile corresponding to the recording device.

In one embodiment of the present invention, in which the call server comprises a driver 121 and a call manager 122, the call manager receives the answer message 309 and then transmits an answer message 310 to the driver 121. The driver is then responsible for transmitting the update message 311 as described above, and for receiving the answer message 312 as defined above. Then, the answer message 312 is received by the driver 121 and transmitted to the call manager 122 in the form of a message 313.

After the message 314 has been received by the calling terminal 14, the requested call is set up. A first part 315 of the established call corresponds to the exchanges of data between the calling terminal 14 and the recording device 16; and a second part 316 of the call corresponds to the exchanges of data between the recording device and the called terminal 15.

In practice, on the one hand, the called party, that is the terminal 15, has received, via the call setup request message 307, the call profile of the recording device 16, that is, the terminal 15 knows an address in the network to which the call data must be sent. This address corresponds to the address of the recording device 16. Also, the calling party, that is the terminal 14, has also received the called call profile corresponding to the recording device 16. Thus, the data exchanged between the terminals 14 and 15 passes through the recording device 16 which can then record it.

The call server 12 is therefore responsible for modifying the calling call profile in the setup request message 306 addressed to the called party and the called call profile in the call answer message 314 addressed to the calling party.

FIG. 3 illustrates an exchange of messages as described above with reference to FIG. 2, in the case where the SIP protocol is used to exchange the call information between the two call servers 12 and 13.

In this context, the messages 401-405 correspond to the messages 301-305, as previously described in the context of the call server 12 comprising a driver 121 and a call manager 122, with reference to FIG. 3.

Then, on receiving the message 405, equivalent to the message 305 in FIG. 2, the call manager 122 of the call server 12 transmits an “INVITE” call setup request message 406 according to the SIP protocol to the call server 13. This request message 406 indicates a calling call profile relative to the recording device 16. This call profile comprises a list of SDPs (Session Description Protocols) as defined by document RFC 2327 (RFC standing for Request For Comment), defined by the IETF (Internet Engineering Task Force). An SDP indicates in particular the type of medium used for the call currently being set -up. The medium can be, for example, of audio type or even of video type. An SDP can also indicate the protocol used to transfer the data during the call currently being set up. This protocol can be, for example, of RTP/UDP/IP type, or of H.320 type corresponding to a standard created by the ITU-T (International Telecommunication Union—Telecommunication standardization). An SDP can also indicate a format of the medium indicated above. Thus, for example, when the medium is of video type, it is possible to indicate an H.261 video type or even an MPEG (Moving Picture Experts Group) type format.

An SDP also indicates addresses in the telecommunication network concerned, like an identifier of an IP/RTP port for the receipt of data by the recording device 16.

On receiving this setup request message 406, the call server 13 then transmits to the terminal 15 a message 407 corresponding to the message 307 described previously. In the context of a voice-type call for example, the reception of the latter message by the terminal 15 can correspond to a ringing phase on this terminal 15.

Then, the terminal 15 responds to this message 407 with a ringing acknowledgement message 408 to the call server 13. On receiving this acknowledgement message 408, the call server 13 transmits to the call server 12 a “180” acknowledgement message 409 according to the SIP protocol.

When the called terminal 15 answers the duly initiated call, an answer message 410 is transmitted from this terminal 15 to the call server 13. On receiving this message 410, the call server 13 transmits to the call server 12 a message 411 according to the SIP protocol indicating that the call is answered, this message corresponding to a “200 OK” message. This message indicates the called call profile of the terminal 15.

To this end, it comprises an SDP relating to the terminal 15. The SDP of the terminal 15 is defined on the basis of the list of the SDPs received in the setup request message 406 relating to the recording device 16.

The call server 12 responds to this message 411 by transmitting an acknowledgement message 412 to the call server 13 which corresponds to an “Ack” message according to the SIP protocol.

Then, the messages 413-417 correspond respectively to the messages 310 to 314 as described above.

FIG. 4 illustrates another exchange of messages between a calling terminal, a called terminal and various network elements according to one embodiment of the present invention, when the terminal concerned is the called terminal and when the calling terminal and the called terminal are in different-type respective telecommunication networks.

In this context, the calling terminal corresponds to an analog terminal 41. It is located in an analog-type network. It is managed by a gateway call server 43 which is suitable for interconnecting the analog network with an IP-type network. The called terminal corresponds to the IP-type terminal 14. It is located in an IP-type network. The calls from this terminal 14 are managed by the call server 12, which is linked to the recording device 16.

The analog terminal 41 initiates a call to the IP terminal 14. In such a network architecture, the analog terminal transmits a call setup request message 601 to the gateway call server 43. This gateway call server 43 transmits this call setup request to the call server 12 in the form of a setup request message 602.

On receiving this message 602, the call server 12 transmits a recording initiation message 603 to the recording device 16. On receiving this message, as described with reference to FIGS. 2 and 3, the recording device 16 prepares its configuration for a recording of data streams intended for the terminal 14 and/or originating from the terminal 14. This initiation message comprises a calling call profile corresponding to the terminal 41.

Then, the recording device 16 responds to the call server 12 by transmitting an acknowledgement message 604.

At this stage, the call server 12 can on the one hand respond to the call setup request message 602 and on the other hand transmit a call setup request to the terminal 14.

To this end, it transmits an acknowledgement message 605 to the gateway call server 43. The latter transmits this message 605 to the analog terminal 41 in the form of a message 606 according to the protocol used between this gateway call server and the analog terminals that it manages.

The call server 12 also transmits the call setup request 602 to the terminal 14 in the form of a call setup request message 607 according to the protocol used between this call server 12 and the terminals that it manages.

When the call initiated is answered on the terminal 14, the latter transmits an answer message 608 to the call server 12. The call server 12 then transmits to the recording device 16 an update message 611 indicating the called call profile corresponding to the terminal 14.

The recording device 16 responds to this message in the form of an acknowledgement message 612 to the call server 12, this message indicating that the recording device is ready to record the upcoming call between the calling terminal 41 and the called terminal 14.

Then, the call server 12 transmits the answer message 608 in the form of a message 609, according to the protocol used between the call server 12 and the gateway server 43, to the gateway server 43.

The gateway call server 43 on the one hand transfers the answer message 609 to the analog terminal 41 in the form of a message 613 according to the protocol used between them, and on the other hand responds to the call server 12 in the form of an acknowledgement message 610.

The requested call is then set up so that a data stream transmitted between the terminals 41 and 14 passes through the recording device to be recorded therein according to one embodiment of the present invention.

According to a first part 614 of the established call, the data is transmitted according to a PCM-type protocol (PCM standing for Pulse Code Modulation) between the calling terminal 41 and the gateway call server 43. Then, on a second part of the call 615, the data is transmitted according to an IP RTP-type protocol (standing for Internet Protocol, Real Time Protocol) between the gateway call server and the recording device 16. Finally, on a third part 616 of the call, the data is transmitted according to a protocol that is also of IP RTP type between the recording device 16 and the called terminal 14.

The call is, as described previously, set up according to a first part 315 between the calling party 41 and the recording device 16 and a second part between the recording device 16 and the called party 14.

In practice, the terminal 41 has a called call profile which corresponds to the recording device 16. Consequently, all the data transmitted during this established call passes through this recording device. Then, the terminal 14 has a calling call profile which corresponds to the recording device, and all the data transmitted during this call by this terminal 14 also passes through the recording device 16.

FIG. 5 details an exchange of messages between the gateway call server 43 and the call server 12 according to an SIP-type protocol, in the context described above with reference to FIG. 4.

On receiving a call setup request message 701, the gateway call server 43 transmits to the call server 12 an “INVITE” message 702 indicating a calling call profile corresponding to the terminal 41. Such a message can thus indicate an SDP list relative to the terminal 41, as described above. Then, a recording initiation message 703 is transmitted to the recording device 16.

As with reference to FIG. 4, the recording device 16 is prepared for the recording concerned and responds with an acknowledgement message 704. The call server 12 can then on the one hand transmit a call setup request message 705 to the terminal 14, and on the other hand transmit to the gateway call server 43 a “180” acknowledgement message 706 according to the SIP protocol. The latter message is transmitted to the terminal 41 in the form of a message 707.

Then, the called terminal 14 answers the current call, and an answer message 708 is transmitted from this terminal to the call server 12.

The call server 12 then transmits to the recording device 16 an update message 712 which indicates the called call profile relating to the called terminal 14. The recording device 16 acknowledges the correct reception of this update message by transmitting an acknowledgement message 713 to the call server 12.

The latter then transmits the answer message 708 in the form of a “200 OK” message 709 according to the SIP protocol to the gateway call server 43. The latter message indicates an SDP relating to the recording device 16.

The gateway call server 43 then transmits to the call server 12 an “Ack” acknowledgement message 710 according to the SIP protocol.

At this stage, the requested call is set up, as previously described with reference to FIG. 4.

FIG. 6 illustrates a call server according to one embodiment of the present invention. The call server 12 is suitable for recording a call between a calling terminal and a called terminal in a telecommunication network.

This call server is linked to at least one recording device 16 and manages a given terminal 14 corresponding either to the calling terminal or to the called terminal.

This call server comprises a first interface unit 802 with the recording device suitable for, on the one hand, transmitting, on receipt of a call, or communication, setup request, to the recording device, a recording initiation message 303, 603 indicating the first calling call profile, that is, the one that corresponds to the calling terminal; and, on the other hand, transmitting an update message 311 or 611 indicating the first called call profile, that is, the one that corresponds to the called terminal.

It also comprises a second interface unit 801 with the calling terminal suitable for, on the one hand, receiving a call, or communication, setup request 301, indicating the first calling call profile corresponding to the calling terminal and a called party identifier corresponding to the called terminal; and, on the other hand, transmitting a call answer message 314 or 609 indicating a second called call profile corresponding to the recording device.

It also comprises a third interface unit 803 with the called terminal suitable for, on the one hand, transmitting to the called terminal a call setup request 306, 607 indicating a second calling call profile corresponding to said recording device; and, on the other hand, receiving from the called terminal a call setup response 309, 608 indicating the first called call profile corresponding to the called terminal.

The call server is therefore suitable for setting up a call, on the one hand, according to a first call part between the calling terminal and the recording device, and, on the other hand, according to a second call part between the recording device and the called terminal.

The call server 12 can also comprise a management unit 804 suitable for managing a list of identifiers relating respectively to a plurality of terminals managed by this call server, for determining whether the calling call profile and/or the called party identifier indicated in a call setup request received by the second interface unit 801 corresponds to an identifier in the list; and for deciding whether recording of the call being set up is required.

The call server can be linked to a plurality of recording devices 16. In this context, it can also comprise a recording device selection unit suitable for selecting a recording device from the plurality of recording devices according on the one hand to information indicated in the call profile of the calling party and on the other hand to information relating to the recording devices of the plurality.

FIG. 6 also illustrates a recording device according to one embodiment of the present invention. This call recording device 16 is linked to a call server 12 as described previously.

This recording device comprises a first interface unit 901 with the call server suitable for, on the one hand, receiving a recording initiation message 303 or 603 indicating a calling call profile corresponding to the calling terminal; and on the other hand, receiving an update message 311 or 611 indicating a called call profile corresponding to the called terminal.

It also comprises a memory 904 suitable for storing information exchanged between the calling terminal and the called terminal. It also comprises a second interface unit 902 suitable for, on the one hand, receiving and storing in the memory the information transmitted by the calling terminal and, on the other hand, transmitting to the calling terminal the information received by a third interface unit. It also comprises the third interface unit 903 suitable for, on the one hand, receiving and storing in the memory the information transmitted by the called terminal and, on the other hand, transmitting to the called terminal the information received by the second interface unit.

1. A call recording method for a given terminal (14), during a call between a calling terminal and a called terminal in a telecommunication network (11),
said given terminal, corresponding to the calling terminal or to the called terminal, being managed by a call server (12),
the call server being linked to at least one recording device (16);
said method comprising the following steps, implemented on the call server:
a) receiving a call setup request (301, 602) indicating a first calling call profile corresponding to the calling terminal and a called party identifier corresponding to the called terminal;
b) transmitting to the recording device a recording initiation message (303, 603) indicating said calling call profile corresponding to the calling terminal;
c) transmitting to the called terminal, a call setup request (306, 607) indication a second calling call profile corresponding to said recording device;
d) receiving from the called terminal a call setup response (309, 608) indicating a first called call profile corresponding to the called terminal;
e) transmitting, on the one hand, to the recording device, an update message (311, 611) indicating the first called call profile corresponding to the called terminal and, on the other hand, transmitting to the calling terminal a call answer message (314, 609) indicating a second called call profile corresponding to said recording device;
in which the call is set up, on the one hand, according to a first call part between the calling terminal and the recording device and, on the other hand, according to a second call part between the recording device and the called terminal, and
in which the recording device records data concerning the call received from the calling terminal and/or data concerning the call received from the called terminal.

2. The recording method as claimed in claim 1, in which, when recording is required for a plurality of terminals of the telecommunication network that are managed by the call server (12), the call server manages a list of identifiers relating to the terminals of said plurality of terminals, and in which the steps b) to e) are implemented only if the calling call profile and/or the called party identifier correspond(s) to an identifier in said list.

3. The recording method as claimed in claim 1, in which, when the telecommunication network is based on an IP (Internet Protocol) type protocol, a call profile comprises at least an IP address and an LP port for receiving data.

4. The recording method as claimed in claim 1, in which the call server (12) manages a list of recording devices, and in which the call server selects a recording device from said recording devices in said list according on the one hand to information indicated in the call profile of the calling party and on the other hand to information relating to the recording devices in said list.

5. A call server (12) suitable for recording a call between a calling terminal and a called terminal in a telecommunication network,
said call server being linked to at least one recording device (16) and managing a given terminal (14) corresponding to the calling terminal or to the called terminal;
said call server comprising:
a first interface unit (802) with the recording device suitable for:
transmitting, on receipt of a call setup request, to the recording device, a recording initiation message (303, 603) indicating a first calling call profile corresponding to the calling terminal; and
transmitting to the recording device an update message (311, 611) indicating a first called call profile corresponding to the called terminal;
a second interface unit (801) with the calling terminal suitable for:
receiving from the calling terminal a call setup request (301) indicating the first calling call profile and a called party identifier corresponding to the called terminal; and
transmitting to the calling terminal a call answer message (314, 609) indicating a second called call profile corresponding to said recording device;
a third interface unit (803) with the called terminal suitable for:
transmitting to the called terminal a call setup request (306, 607) indicating a second calling call profile corresponding to said recording device; and
receiving from the called terminal a call setup response (309, 608) indicating the first called call profile;
said call server being suitable for setting up a call, on the one hand, according to a first call part between calling terminal and the recording device, and, on the other hand, according to a second cal part between the recording device and the called terminal.

6. The call server (12) as claimed in claim 5, also comprising a management unit (804) suitable for:
managing a list of identifiers relating respectively to a plurality of terminals managed by said call server;
determining whether the first calling call profile and/or the called party identifier indicated in a call setup request received by the second interface unit corresponds to the an identifier in said list; and
deciding whether recording of the call being set up is required.

7. The call server as claimed in claim 5 or 6, linked to a plurality of recording devices (16), also comprising a recording device selection unit suitable for selecting a recording device from the plurality of recording devices according on the one hand to information indicated in the first call profile of the calling party and on the other hand to information relating to the recording device of the plurality.

8. A call recording device (16) linked to a call server (12) suitable for recording a call relating to a given terminal (14), during a call between a calling terminal and a called terminal in a telecommunication network (11), said given terminal, corresponding to the calling terminal or to the called terminal, being managed by the call server (12),
said recording device comprising:
a first interface unit (901) with the call server suitable for:
receiving a recording ignition message (303, 603) indicating a first calling call profile corresponding to the calling terminal; and
receiving an update message (311, 611) indicating a first called call profile corresponding to the called terminal; and
a memory (904) suitable for storing information exchanged between the calling terminal and the called terminal;
a second interface unit (902) suitable for, on the one hand, receiving and storing in said memory the information transmitted by the calling terminal and, on the other hand, transmitting to the calling terminal the information received by a third interface unit; and
said third interface unit (903) suitable for, on the one hand, receiving and storing in said memory the information transmitted by the called terminal and, on the other hand, transmitting to the called terminal the information received by said second interface unit.

9. (canceled)

10. A call server as claimed in claim 5, and further including a recording device, the recording device comprising:
call recording device (16) linked to the call server (12) and suitable for recording a call relating to a given terminal (14), during a call between a calling terminal and a called terminal in a telecommunication network (11), said given terminal, corresponding to the calling terminal or to the called terminal, being managed by the call server (12),
said recording device further comprising:
a first interface unit (901) with the call server suitable for:
receiving a recording ignition message (303, 603) indicating a first calling call profile corresponding to the calling terminal; and
receiving an update message (311, 611) indicating a first called call profile corresponding to the called terminal; and
a memory (904) suitable for storing information exchanged between the calling terminal and the called terminal;
a second interface unit (902) suitable for, on the one hand, receiving and storing in said memory the information transmitted by the calling terminal and, on the other hand, transmitting to the calling terminal the information received by a third interface unit; and
said third interface unit (903) suitable for, on the one hand, receiving and storing in said memory the information transmitted by the called terminal and, on the other hand, transmitting to the called terminal the information received by said second interface unit.
